(19) United States
(12) Patent Application Publication
(10) Pub. No.: US 2012/0043941 A1
(43) Pub. Date: Feb. 23, 2012

(54) AUTOMATIC BATTERY SAFETY PROTECTION SYSTEM

(76) Inventor: TAIANN LEE, New Taipei City (TW)

(21) Appl. No.: 13/212,191

(22) Filed: Aug. 18, 2011

(30) Foreign Application Priority Data
Aug. 20, 2010 (TW) 099127853

(51) Int. Cl. H02J 7/00

(52) U.S. Cl. 320/134

(57) ABSTRACT

The present invention provides an automatic battery safety protection system, which includes at least one battery pack, a Micro-Electro-Mechanical System (MEMS), a battery management system and a power supply management system. The MEMS controls the battery pack to put it in a charge mode, a discharge mode or a sleep mode, and detects an environmental situation and transfers a detection result as an electronic signal. The battery management system is connected to the battery pack and supplies power to the battery pack. The power supply management system supplies power to the battery management system according to the electronic signal and controls the battery management system to make the battery pack take a corresponding action. The protection system of the present invention can achieve practical improvements such as protecting the battery pack system, extending the lifespan of the battery, and avoiding a false action.

### BACKGROUND OF THE INVENTION

(a) Technical Field of the Invention

The present invention relates to a battery safety protection system. More particularly, the present invention relates to an automatic battery safety protection system capable of preventing a battery from charging or discharging in an abnormal situation.

(b) Description of the Prior Art

Among all sorts of energy resources, oil is the most important one, which not only provides convenience for our daily life but also brings continuous progress to technology and quality of human life (e.g., oil may be used for driving a carrier, used as a raw material for various plastic products, and even used for generating power). However, oil has a limited reserve, and may run out due to long-term uncontrolled exploitation by human beings.

As many developing countries gradually become developed countries, economic growth greatly raises the demand for oil. However, when used for producing energy, oil may cause pollution (e.g. air pollution, greenhouse air, and even livestock changes caused by climate changes), so all countries are dedicated to researching and developing alternative energy resources (e.g. solar energy battery, biomass energy generation, wind power generation, hydroelectric power generation and the like).

Currently, governments of all countries have made efforts to research the use of power to drive a carrier, and an electric-powered vehicle will not emit toxic air and is only installed with a high-performance battery to be powered by the battery after being charged.

However, the above electric-powered vehicle in use still has the following problems and defects to be overcome.

The charging of the electric-powered vehicle takes a period of time and the battery is at a risk of a short circuit. If the short circuit of the connecting heads occurs in the course of charging, an unexpected danger may occur. Due to continuous discharging, when the electric-powered vehicle encounters a sudden situation such as a car accident while running, the battery should stop discharging to avoid the occurrence of danger. Directed to the current defects, it is urgent to develop a battery protection mechanism system.

Therefore, the aim of the research and development to be conducted by the present inventor and relevant manufacturers engaged in this industry is how to solve the problems and deficiencies encountered in the prior art.

### SUMMARY OF THE INVENTION

Accordingly, in view of the above defects, after the collection of relevant data, evaluation and consideration in full scale, the present inventor designs an automatic battery safety protection system capable of preventing a battery from charging or discharging in an abnormal situation based on many years of experience accumulated in this industry and via continual experiments and modifications.

The present invention is mainly directed to providing a battery protection system capable of preventing a battery from charging or discharging in an abnormal situation.

To achieve the above objective, the present invention is applicable to a battery pack of a carrier, and includes at least one battery pack, a Micro-Electro-Mechanical System (MEMS), a battery management system and a power supply management system. The MEMS controls the battery pack to put it in a charge mode, a discharge mode and a sleep mode, and the MEMS detects an environmental situation and transfers a detection result as an electronic signal. The battery management system is connected to the battery pack, and supplies power to the battery pack. The power supply management system supplies power to the battery management system according to the electronic signal and controls the battery management system to make the battery pack take a corresponding action.

By way of the present invention, when the battery pack of the carrier (e.g. a motorcycle) is in the charge mode and the battery pack is charging, if the body of the motorcycle becomes oblique or moves violently to-and-fro and side-to-side or the charging clamp or charger drops when charging or another similar situation occurs, the MEMS detects that the current situation is abnormal and transfers an electronic signal to the power supply management system. The power supply management system then controls the battery management system to restrict the discharging current of the battery pack or stop discharging according to the electronic signal. Further, when the battery is in the discharge mode and supplies power to the motorcycle, if the speed of the motorcycle exceeds a preset speed and the body of the motorcycle is oblique to a preset horizontal angle and thus is under a violent action force or reaction force, the MEMS detects that the current situation is abnormal and transfers an electronic signal to the power supply management system. The power supply management system controls the battery management system to restrict the discharging current of the battery pack or stop discharging according to the electronic signal. The above situations are also applicable to the sleep mode. By use of the above system, the present invention may effectively achieve the purpose of automatically restricting the current of the battery and even cutting off the power supply, thereby achieving practical improvements such as protecting the battery pack system, extending the lifespan of battery, and avoiding a false action.

### BRIEF DESCRIPTION OF THE DRAWINGS

FIG. 1 is a block diagram of a preferred embodiment of the present invention;

FIG. 2 is a schematic view 1 of a preferred embodiment of the present invention;

FIG. 3 is a schematic view 2 of a preferred embodiment of the present invention; and

FIG. 4 is a schematic view 3 of a preferred embodiment of the present invention.

### DETAILED DESCRIPTION OF THE PREFERRED EMBODIMENTS

To achieve the above objectives and efficacy, these and other features, aspects, and advantages of the present invention will become better understood with reference to the following description and appended claims.

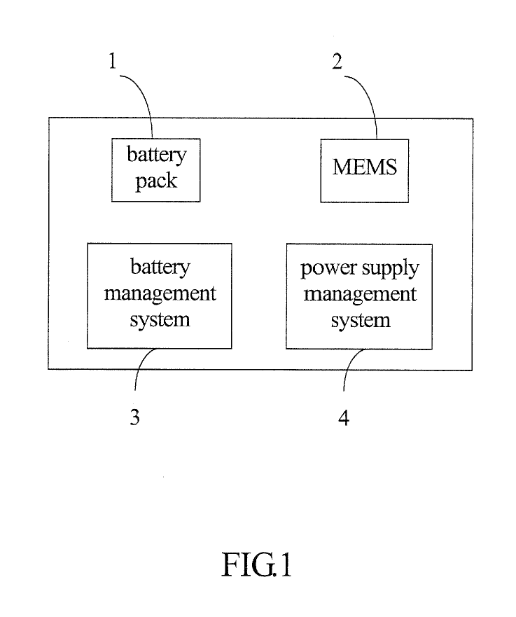

FIG. 1 is a block diagram of a preferred embodiment of the present invention. Referring to FIG. 1, the battery protection system of the present invention includes:

at least one battery pack 1;

a Micro-Electra-Mechanical System (MEMS) 2, for controlling the battery pack 1 to put it in a charge mode, a discharge mode or a sleep mode and detecting an environmental situation and transferring a detection result as an electronic signal;

a battery management system 3, connected to the battery pack 1, for supplying power to the battery pack 1, in which the MEMS 2 may further be connected to the battery management system 3; and

a power supply management system 4, for supplying power to the battery management system 3 according to the electronic signal and controlling the battery management system 3 to make the battery pack 1 to take a corresponding action.

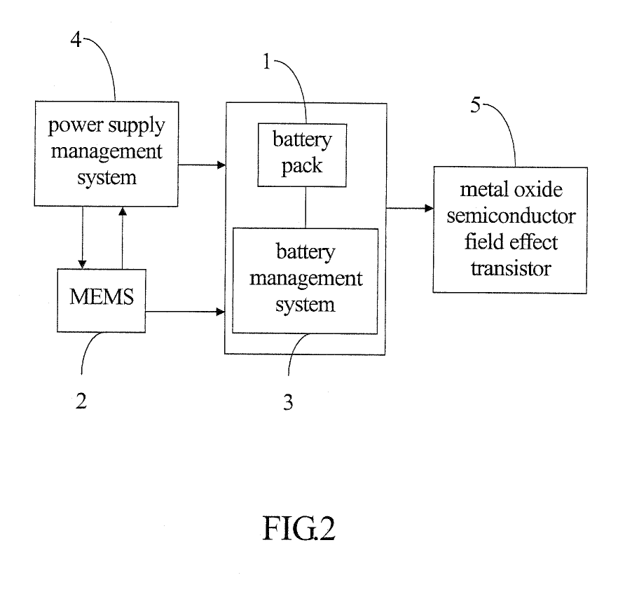

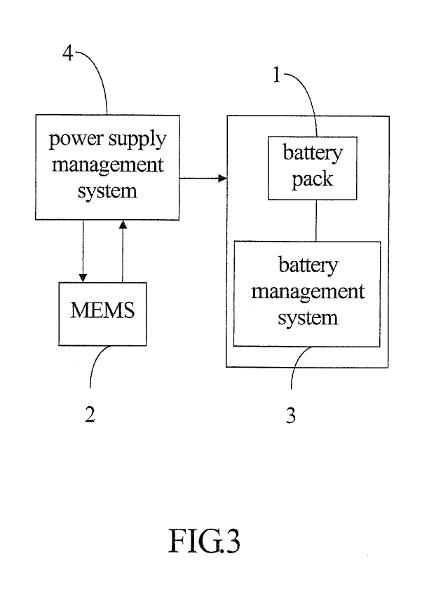

By way of the above structure and composition design, the use of the present invention is illustrated as follows. FIGS. 2, 3, and 4 are schematic views 1, 2, and 3 of a preferred embodiment of the present invention. It can be clearly seen from the figures that the present invention is applicable to the battery pack 1 of a carrier (e.g. electric car, electric motorcycle and electronic bus). The MEMS 2 of the present invention may control the battery to put it in a charge mode, a discharge mode and a sleep mode. When the battery is in the charge mode (as shown in FIG. 2), if the carrier body is oblique or the body moves violently to-and-fro and side-to-side or the charging clamp or charger drops when charging or another similar situation occurs, continuous charging may cause the danger of a short circuit. The MEMS 2 of the present invention detects that the current situation is abnormal, and transfers an electronic signal to the power supply management system 4. The power supply management system 4 may then control the battery management system 3 to restrict the discharging current of the battery pack 1 or stop discharging according to the electronic signal. In this way, a dangerous circumstance like the short circuit of the battery pack 1 can be avoided, as shown in the figures. In practice, the battery pack 1 is controlled through a metal oxide semiconductor field effect transistor 5. When the battery pack 1 operates normally, the metal oxide semiconductor field effect transistor 5 can be used to maintain the normal operation of the battery pack, but when an abnormal situation occurs, the metal oxide semiconductor field effect transistor 5 may control the discharging current of the battery pack 1 or stop discharging. When the battery is in the discharge mode (as shown in FIG. 3), normally, the battery discharges in the carrier for use. In this case, when the speed of the carrier exceeds a preset speed, the MEMS 2 detects the current situation and transfers an electronic signal to the power supply management system 4 to make the power supply management system 4 restrict the charging power of the battery pack 1 and further restrict the speed of the carrier, thereby achieving the effect of safety protection to avoid over-speeding.

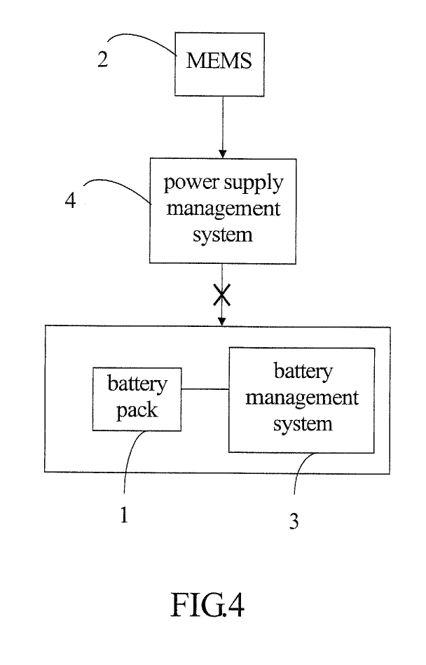

Furthermore, when the battery pack 1 is in the sleep mode (as shown in FIG. 4), the carrier may be not in use, and the present invention provides an antitheft function. If the battery pack 1 is detached or the signal wire is pulled out in the case of locking, it is probable that a thief is attempting to steal the carrier, and in this case the MEMS 2 may detect that the current situation is abnormal and transfers an electronic signal to the power supply management system 4. The power supply management system 4 determines that the current situation is abnormal according to the electronic signal, and forcibly cuts off the power supply to the battery pack 1.

Therefore, the automatic battery safety protection system of the present invention has the following key techniques that overcome the defects of the prior arts:

The MEMS 2 of the present invention controls the battery to put it in a charge mode, a discharge mode or a sleep mode, and takes different actions according to different modes. The system of the present invention achieves practical improvements such as effectively protecting the battery pack 1, extending the lifespan of the battery, and avoiding a false action.

While the present invention has been described with reference to certain preferred embodiments, those of skill in the art will appreciate that the above preferred embodiments are only used to explain the present invention and does not limit the protection scope of the present invention. Various modifications, equivalent replacements, improvements and so on without departing from the spirit and scope of the invention as recited in the claims, are all included in the rights protection scope of the present invention.

I claim:

1. An automatic battery safety protection system, applicable to a carrier, comprising:
at least one battery pack;
a Micro-Electro-Mechanical System (MEMS), capable of controlling the battery pack to put it in a charge mode, a discharge mode or a sleep mode, and used for detecting an environmental situation and transferring a detection result as an electronic signal;
a battery management system, connected to the battery pack, for supplying power to the battery pack; and
a power supply management system, for supplying power to the battery management system according to the electronic signal and controlling the battery management system to make the battery pack take a corresponding action.

2. The automatic battery safety protection system of claim 1, wherein the MEMS is further connected to the battery management system.
